(19) United States
(12) Patent Application Publication
(10) Pub. No.: US 2026/0178573 A1
(43) Pub. Date: Jun. 25, 2026

(54) SYSTEM AND METHOD FOR DOMAIN SPECIFIC RETRIEVAL AWARE GRAPHQL GENERATING LARGE LANGUAGE MODELS FOR AUTOMATED QUERYING OF GRAPHQL SCHEMAS

(71) Applicant: Intuit Inc., Mountain View, CA (US)

(72) Inventors: Tharathorn Joy Rimchala, San Francisco, CA (US); Daniel Leontin Moise, Edmonton (CA); Hui Chen, San Jose, CA (US); Horace Chan, Edmonton (CA); Daniel Li, Frisco, TX (US); Rachit Sengupta, San Diego, CA (US); Sivashanker Thiruchittampalam, Toronto (CA)

(73) Assignee: Intuit Inc., Mountain View, CA (US)

(21) Appl. No.: 18/990,973

(22) Filed: Dec. 20, 2024

(51) Int. Cl. G06F 16/2452; G06F 16/14

(52) U.S. Cl. CPC G06F 16/24522; G06F 16/152

(57) ABSTRACT

A GraphQL query generation system uses a tunable Retrieval-Augmented Generation (RAG) architecture that includes a top-K predictor that receives natural language queries and predicts a number of items to be retrieved by a retriever for each natural language query. A retriever receives the natural language queries and in response retrieves a set of top-K attributes associated with the natural language queries and the number of items to be retrieved as provided by the top-K predictor. The retriever may be a neural database retriever that is configured to perform a multiple class hash key prediction by encoding the natural language query with a hash key and retrieving attributes that are assigned a same hash key. The GraphQL query generating large language model (LLM) receives the natural language queries and the set of top-K attributes and in response generate the GraphQL queries. The top-K predictor and the LLM are co-trained together.

### TECHNICAL FIELD

This disclosure relates generally to GraphQL query generation, and specifically to automated generation of domain specific GraphQL queries with Large Language Models.

### BACKGROUND

GraphQL supergraphs and subgraphs may be an extremely large schema with thousands of entities, types and fields, which makes it difficult for an engineer to find the correct fields for retrieving needed data. Large Language Models (LLMS) may be used to assist in this process. For example, LLM based solutions typically use Retrieval-Augmented Generation (RAG) based GraphQL query generation using third party or open-source LLMs. RAG, in general, is a process of optimizing the output of an LLM to enable the LLM to reference a domain specific knowledge base external to the training data sources for the LLM. For example, in response to a given query, RAG uses a domain specific document retriever to retrieve the most relevant data, e.g., information or documents, from a retrieval database. The retrieved data is combined with the query and provided as an input to the LLM. The LLM uses its pre-trained knowledge and the retrieved data to generate a response to the query.

Thus, for developer productivity use cases, two main components of the LLM based GraphQL generations are 1) Retrieval: identifying the right set of attributes in the schema to retrieve, and 2) Generation: generating the executable GraphQL queries to retrieve the data elements associated with those attributes. For retrieval, currently systems typically rely on fetching the top-K most similar attributes, e.g., based on the cosine similarity of the natural language attribute description and the natural language developer's queries in the embedding space of pretrained embedding models. Additionally, for generation of the executable GraphQL queries, current systems typically rely on using the subschemas associated with fetched top-K attributes to prompt the third party or open source LLMs for query generation.

In general, however, current systems are unsatisfactory in generating queries against the user's graphs or supergraphs. For example, current systems relying on domain general LLMs have failures associated with hallucinated attributes, invalid schema and inexecutable queries against user's graphs or supergraphs.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

A GraphQL query generation system uses a Retrieval-Augmented Generation (RAG) architecture that includes a top-K predictor that receives natural language queries and in response predicts a number of items to be retrieved by a retriever for each natural language query. A retriever receives the natural language queries and in response retrieves a set of top-K attributes associated with the natural language queries and the number of items to be retrieved as provided by the top-K predictor. The retriever may be a neural database retriever that is configured to perform a multiple class hash key prediction by encoding the natural language query with a hash key and retrieving attributes that are assigned a same hash key. The GraphQL query generating large language model (LLM) receives the natural language queries and the set of top-K attributes and in response generates the GraphQL queries. The top-K predictor and the LLM are co-trained together and are trained on loss terms including at least one of hallucination reduction loss, schema validity loss, and query executability loss.

One innovative aspect of the subject matter described in this disclosure can be implemented as a system configured for GraphQL query generation. The system includes one or more processors, and a memory communicatively coupled with the one or more processors and storing instructions that, when executed by the one or more processors, causes the one or more processors to be configured as a top-K predictor that is configured to receive natural language queries and in response predict a number of items to be retrieved for each natural language query. The one or more processors are further configured as a retriever that is configured to receive the natural language queries and in response retrieve a set of top-K attributes based on a plurality of ranked attributes associated with the natural language queries and the number of items to be retrieved. The one or more processors are further configured as a large language model that is configured to receive the set of top-K attributes and the natural language queries and in response generate GraphQL queries.

One innovative aspect of the subject matter described in this disclosure can be implemented as a method for GraphQL query generation, including receiving a natural language query from a user via an electronic interface and determining, with a top-K predictor based on the natural language query, a number K of items to be retrieved by a retriever in response to the natural language query. The method may further include retrieving a set of top-K attributes associated with the natural language query with the retriever based on the number K of items to be retrieved determined by the top-K predictor. The method may further include generating a GraphQL query with a large language model in response to the natural language query and the set of top-K attributes.

One innovative aspect of the subject matter described in this disclosure can be implemented as a method for training a system for GraphQL query generation including constructing a training dataset with fields including natural language query, supporting attributes, attribute minimal subschemas, and executable GraphQL query. The method further includes training a retriever to retrieve a plurality of ranked attributes associated with natural language queries. The method further includes co-training a top-K predictor and a large language model together using the training dataset and the plurality of ranked attributes retrieved by the retriever in response to natural language queries. The top-K predictor is trained to predict a number of items to be retrieved by the retriever in response to the natural language queries and the large language model is trained to generate GraphQL queries in response to a set of top-K attributes retrieved by the retriever and the natural language queries.

One innovative aspect of the subject matter described in this disclosure can be implemented as a system configured for GraphQL query generation including one or more processors, and a memory communicatively coupled with the one or more processors and storing instructions that, when executed by the one or more processors, causes the one or more processors to perform operations. The operations may include constructing a training dataset with fields including natural language query, supporting attributes, attribute minimal subschemas, and executable GraphQL query. The operations may further include training a retriever to retrieve a plurality of ranked attributes associated with natural language queries. The operations may further include co-training a top-K predictor and a large language model together using the training dataset and the plurality of ranked attributes retrieved by the retriever in response to natural language queries. The top-K predictor is trained to predict a number of items to be retrieved by the retriever in response to the natural language queries and the large language model is trained to generate GraphQL queries in response to a set of top-K attributes retrieved by the retriever and the natural language queries.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates a system for GraphQL query generation, according to some implementations.

FIG. 2 illustrates an architecture for generating GraphQL queries using a RAG based system, according to some implementations.

FIG. 3 illustrates a process flow for using the architecture from FIG. 2 to generate GraphQL queries, according to some implementations.

FIG. 4 illustrates a dataset sample for training the components of the system illustrated in FIG. 2.

FIG. 5 illustrates a flowchart depicting an example method for GraphQL query generation, according to some implementations.

FIG. 6 illustrates a flowchart depicting an example method for training a system for GraphQL query generation, according to some implementations.

Like reference numbers and designations in the various drawings indicate like elements.

### DETAILED DESCRIPTION

A Retrieval-Augmented Generation (RAG) application may be used for GraphQL query generation using third party or open-source Large Language Models (LLMs). The main components of the RAG based GraphQL query generations are the retrieval, in which the correct set of attributes in the schema to be retrieved is identified, and generating the executable GraphQL queries to retrieve the data elements associated with those attributes. As discussed herein, a tunable architecture is used to overcome limitations in existing approaches.

Conventional systems, for example, typically perform retrieval by fetching the top-K most similar attributes, e.g., based on the cosine similarity of the natural language attribute description and the natural language developer's queries in the embedding space of pretrained embedding models. Additionally, for generation of the executable GraphQL queries, conventional systems typically rely on using the subschemas associated with the fetched top-K attributes to prompt the third party or open source LLMs for query generation. Components of conventional systems, however, are not fine-tuned with any of domain specific developer's/user's queries or on any information related to the user's graph or supergraph. In addition, there is no ability to dynamically adjust the number of retrieved items (top-K) at runtime. As a result, generation of GraphQL queries using conventional systems sometimes include failures associated with hallucinated attributes, invalid schema and inexecutable queries against the user's graphs or supergraphs.

To address limitations of the existing approaches, a system configured for GraphQL query generation includes a tunable architecture. For example, the system may include a retrieval Top-K predictor that is configured to predict the number of items to be retrieved for each natural language query, which allows the number of retrieved attributes to vary with different natural language queries, e.g., in response to the complexity of the queries. The system may include a retriever that retrieves the top-K attributes based on the predicted number of items to be retrieved. The retrieved attributes may contain associated minimal schema within the user's graph/supergraph. The system may use a retrieval aware LLM that receives the natural language queries and retrieved top-K attributes and in response generates the GraphQL queries. The retriever and the top-K predictor may encode the natural language query with the same encoder. The system may be tuned, e.g., by fine-tuning the retriever using a neural database (NeuralDB) retrieval objective. The system may be further tuned by fine-tuning the top-K predictor and the retriever-aware LLM simultaneously using the tuned retriever. The top-K predictor and retriever-aware LLM, for example, may be co-trained, with the top-K predictor trained to estimate the number of items to retrieve and the LLM trained to maximize the performance of the entire system end-to-end, e.g. penalizing the systems for hallucinations and query executability during the training iterations. Training the system end-to-end is superior to using the natural language ground truth alone since there are multiple possible GraphQL queries that may yield the right query results.

Aspects of the subject matter disclosed herein for GraphQL query generation using a tunable architecture are not a mental process that can be performed in the human mind, for example, because the overall process requires broad knowledge and memories of a large number of attributes in a SuperGraph and the domain knowledge of GraphQL query language. The human mind is not practically capable predicting a number of items to be retrieved by a retriever in response to natural language queries, or retrieving a top-K attributes, such as minimal schema within a SuperGraph, associated with the natural language queries, e.g., based on hash keys for query-result pairs such that query results that are to be retrieved together are assigned the same hash keys, or generating the GraphQL queries in response to the natural language queries and top-K attributes by an LLM. Moreover, various aspects of the present disclosure provide a technical solution to a technical problem that is rooted in computer technology, and specifically related to GraphQL query generation such as lack of fine tuning to domain specific queries or attributes of a graph or supergraph, as well as failures associated with hallucinated attributes, invalid schema and inexecutable queries against the user's graphs or supergraphs. The technical solution provided by the present disclosure includes using a tunable architecture including a top-K predictor, which is co-trained with the LLM, to dynamically filter out additional (extraneous) attributes, a retriever that retrieves the top-K attributes containing associate minimal schema within the graph or subgraph, and the LLM that generates the GraphQL query based on the minimal subschema associated with the retrieved attributes.

Various implementations of the subject matter disclosed herein provide one or more technical solutions to the technical problem of improving the functionality (e.g., speed, accuracy, etc.) of computer-based systems, where the one or more technical solutions can be practically applied to improve on existing techniques for generating GraphQL queries. Implementations of the subject matter disclosed herein provide specific inventive steps describing how desired results are achieved and realize meaningful and significant improvements on existing computer functionality, that is, the performance of computer-based systems operating in the evolving technological field of generating GraphQL queries.

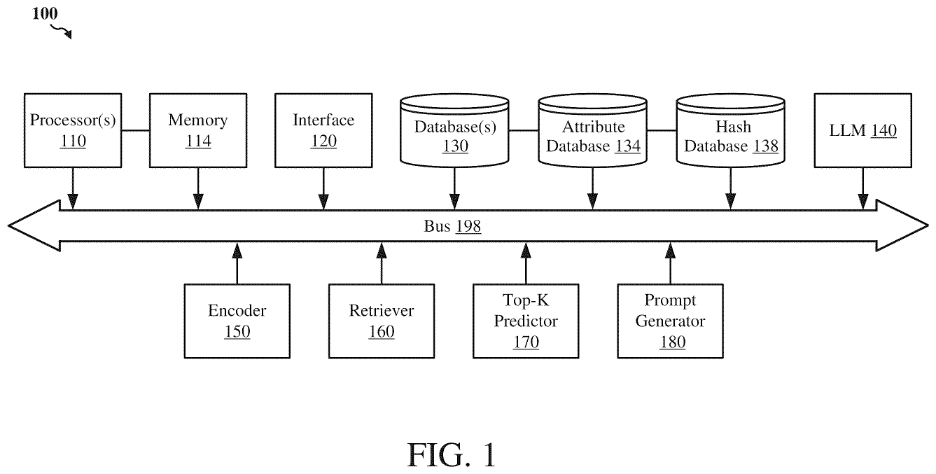

FIG. 1 shows a system 100 for GraphQL query generation, according to some implementations. Various aspects of the system 100 disclosed herein are generally applicable for GraphQL query generation using a RAG based system. The system 100 includes a combination of one or more processors 110, a memory 114 coupled to the one or more processors 110, an interface 120, one or more databases 130, an attribute database 134, a hash database 138, a large language model (LLM) 140, an encoder 150 (embedding model), a retriever 160, a top-K predictor 170, and a prompt generator 180. In some implementations, the various components of the system 100 are interconnected by at least a data bus 198. In some other implementations, the various components of the system 100 are interconnected using other suitable signal routing resources.

The processor 110 includes one or more suitable processors capable of executing scripts or instructions of one or more software programs stored in the system 100, such as within the memory 114. In some implementations, the processor 110 includes a general-purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In some implementations, the processor 110 includes a combination of computing devices, such as a combination of a DSP and a microprocessor, a plurality of microprocessors, one or more microprocessors in conjunction with a DSP core, or any other suitable configuration. In some implementations, the processor 110 incorporates one or more graphics processing units (GPUs) and/or tensor processing units (TPUs), such as for processing a large amount of data.

The memory 114, which may be any suitable persistent memory (such as non-volatile memory or non-transitory memory) may store any number of software programs, executable instructions, machine code, algorithms, and the like that can be executed by the processor 110 to perform one or more corresponding operations or functions. In some implementations, hardwired circuitry is used in place of, or in combination with, software instructions to implement aspects of the disclosure. As such, implementations of the subject matter disclosed herein are not limited to any specific combination of hardware circuitry and/or software.

The interface 120 is one or more input/output (I/O) interfaces for transmitting or receiving (e.g., over a communications network) transmissions, input data, and/or instructions to or from a computing device of a user, outputting data (e.g., over the communications network) to the computing device of the user, providing an input interface for the user and outputting results to the computing device of the user, and the like. Specifically, the interface 120 may be used to receive natural language queries from users and/or to provide GraphQL query results to users. For example, the interface 120 may be used to receive a transmission (e.g., including a query entered by a user of the GenAI system) over the communications network from a computing device associated with the user. As another example, the interface 120 may be used to transmit one or more results over the communications network to the computing device associated with the user. The interface 120 may also be used to provide or receive other suitable information, such as computer code for updating one or more programs stored on the system 100, internet protocol requests and results, or the like. The interface 120, for example, may be used to provide a corpus of data, e.g., specific domains or knowledge base, for the retrieval database, e.g., stored in attribute database 134 and hash database 138. An example interface includes a wired interface or wireless interface to the internet or other means to communicably couple with user devices or any other suitable devices. In an example, the interface 120 includes an interface with an ethernet cable to a modem, which is used to communicate with an internet service provider (ISP) directing traffic to and from user devices and/or other parties. In some implementations, the interface 120 is also used to communicate with another device within the network to which the system 100 is coupled, such as a smartphone, a tablet, a personal computer, or other suitable electronic device. In various implementations, the interface 120 includes a display, a speaker, a mouse, a keyboard, or other suitable input or output elements that allow interfacing with the system 100 by a local user or moderator.

The database 130 stores data associated with the system 100, such as data objects, algorithms, weights, models, modules, engines, user information, values, ratios, historical data, recent data, current or real-time data, files, plugins, extracted data and/or metadata, arrays, tags, identifiers, prompts, queries, replies, feedback, insights, formats, characteristics, features, and/or components, among other suitable information, such as in one or more JavaScript Object Notation (JSON) files, comma-separated values (CSV) files, or other data objects for processing by the system 100, one or more Structured Query Language (SQL) compliant data sets for filtering, querying, and sorting by the system 100 (e.g., the processor 110), or any other suitable format. In various implementations, the database 130 is a part of or separate from the attribute database 134, the hash database 138, and/or another suitable physical or cloud-based data store. In some implementations, the database 130 includes a relational database capable of presenting information as data sets in tabular form and capable of manipulating the data sets using relational operators.

The attribute database 134 stores attributes and subschema associated with a graph or supergraph that are to be retrieved in response to a query by a user for use in generating a GraphQL query for the graph or supergraph. In various implementations, the attribute database 134 may be a part of or separate from the database 130 and/or the hash database 138. In some instances, the attribute database 134 includes data stored in one or more cloud object storage services, such as one or more Amazon Web Services (AWS)-based Simple Storage Service (S3) buckets. In some implementations, all or a portion of the data is stored in a memory separate from the attribute database 134, such as in the database 130, the hash database 138, and/or another suitable data store.

The hash database 138 stores hash data associated with the attributes stored in the attribute database 134. The hash data may be stored in the hash database 138 as dense vector fields in the form of a hierarchical navigable small world (HNSW) graph. In some implementations, the hash database 138 is an Elasticsearch vector database, or another suitable database, such as Pinecone, Milvus, Chroma, Weaviate, Deep Lake, Qdrant, Pgvector, Faiss, ClickHouse, Apache Solr, Vespa, Vald, OpenSearch, Apache Cassandra, or the like. In various implementations, the hash database 138 may be a part of or separate from the database 130 and/or the attribute database 134. In some instances, the hash database 138 includes data stored in one or more cloud object storage services, such as one or more Amazon Web Services (AWS)-based Simple Storage Service (S3) buckets. In some implementations, all or a portion of the data is stored in a memory separate from the hash database 138, such as in the database 130, the attribute database 134, and/or another suitable data store.

The LLM 140 may be any suitable generative artificial intelligence (AI) model trained on a large corpus of text and capable of generating GraphQL queries. The LLM 140 may be further configured to generate written responses, answer questions, and assist with various language-related tasks. To note, the LLM 140 may be pre-trained with vast amounts of domain general textual data (e.g., from the internet), utilize artificial neural networks (ANNs) with millions to billions or even trillions of weights or parameters, be trained through self-supervised and/or semi-supervised methods, incorporate one or more aspects of the transformer architecture and/or mixture of experts (MoE), operate in part based on predicting a next token from an input, fine-tuned to perform various natural language processing (NLP) tasks, and include multiple layers of transformer blocks containing overall billions or even trillions of parameters or weights. The LLM 140, for example, may be a 7B to 13B parameters language model. Example LLMs may include OpenAI's ChatGPT, Google's Bard (PaLM) and/or Google's Gemini, Meta's LLaMa, BigScience's BLOOM, Baidu's Ernie 3.0 Titan, Anthropic's Claude, or another suitable type of ML-based neural network compatible with prompt engineering techniques.

The encoder 150 may be configured to transform a natural language query, or in some implementations, a vector space embedding of the natural language query, into another vector in high dimension space. For example, the natural language query may be processed to generate a dense vector representation (or “embeddings”) of the input. The dense vectors may be (e.g., fixed-sized) arrays of (e.g., floating-point) numbers that can be used as an input to various ML models trained for in various applications, such as search, clustering, information retrieval, and the like. In some implementations, the encoder 150 may be fine-tuned for query-result pairs, such that query results that are to be retrieved together in response to the natural language query are assigned similar hash keys. The encoder 150, for example, may be used to generate the hash keys that are stored in the hash database 138 and attribute database 134, as well as generate hash keys from user queries submitted via the interface 120.

The retriever 160 may be a neural database (neuralDB) based retriever that uses the encoder 150 and a hash key classification head. The retriever 160 is configured to perform multiple class hash key prediction, in which each natural language query (i.e., the natural language query embedding) is encoded into high dimension vector using a transformer text encoder then transformed to a hash key by the hash key prediction head of the neural DB retriever 160 to retrieve attributes from the attribute database 134 based on matching hash keys in the hash database 138. The retriever 160, for example, may use a Merged-Average Classifiers via Hashing (MACH) or other classification algorithm, and may be trained using cross entropy loss to train (optionally the encoder 150 and) the hash key classification head to predict hash keys for query-result pairs such that query results that are to be retrieved together are assigned similar hash keys. The retriever 160 is configured to filter the ranked attributed that are retrieved in response to the natural language query based on the number K of items (attributes) to be retrieved provided by the top-K predictor 170.

The top-K predictor 170 may include a multi-layer perceptron and multi-class classification head that use the embedding vector provided by the encoder 150 and are trained simultaneously with the LLM 140, to tune the top-K predictor 170 to predict a number K of items (attributes) to be retrieved by the retriever 160 in response to each natural language query. The number K of items to be retrieved from the top-K predictor 170 may be provided to the retriever 160, which filters or limits the number of retrieved attributes to the top-K attributes. The top-K predictor 170 performs a multi-class classification operation with the classes being discrete bins of different numbers of items to be retrieved, such as 5, 10, . . . , 100, etc. The top-K predictor 170 may be trained to adjust the number K of items to be retrieved based on various characteristics of the natural language query, such as the complexity of the natural language query.

The prompt generator 180 receives the top-K attributes received by the retriever 160 and generates an LLM input for the LLM 140 that includes the top-K attributes, their corresponding subschemas, and the natural language query. The prompt generator 180, for example, may use a prompt template to generate the LLM input.

The LLM 140, the encoder 150, the retriever 160, the top-K predictor 170, the prompt generator 180, as well as other components, such as an embedding model, are implemented in software, hardware, or a combination thereof. In some implementations, any one or more of the LLM 140, the encoder 150, the retriever 160, the top-K predictor 170, the prompt generator 180 is embodied in instructions that, when executed by the processor 110, cause the system 100 to perform operations. In various implementations, the instructions of one or more of said components, the interface 120, the attribute database 134, and/or hash database 138, are stored in the memory 114, the database 130, or a different suitable memory, and are in any suitable programming language format for execution by the system 100, such as by the processor 110. It is to be understood that the particular architecture of the system 100 shown in FIG. 1 is but one example of a variety of different architectures within which aspects of the present disclosure can be implemented. For example, in some implementations, components of the system 100 are distributed across multiple devices, included in fewer components, and so on. While the below examples related to RAG based system for GraphQL query generation are described with reference to the system 100, other suitable system configurations may be used.

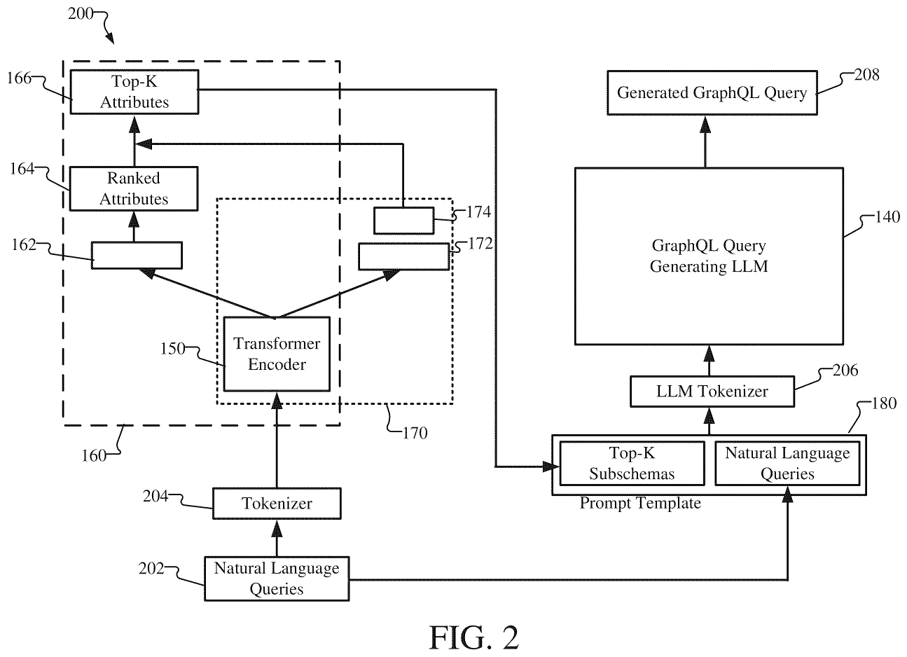

FIG. 2 illustrates an example tunable architecture 200 configured for GraphQL query generation using a RAG based system that includes a retriever 160, a top-K predictor 170, and a GraphQL query generating LLM 140, as discussed in reference to FIG. 1. It should be further understood that the architecture 200 may include additional components that are not illustrated in FIG. 2. Moreover, it should be understood that architecture 200 illustrated in FIG. 2 is generalized and that if desired other components or process steps may be undertaken in various implementations.

As illustrated, natural language queries 202 generated by a user via a computing device are provided to the system, e.g., through interface 120 shown in FIG. 1. The natural language queries 202 are provided to tokenizer 204 that operates on the text from the natural language queries 202 to split text into a sequence of subword tokens and encode the token sequence into an integer array which is an input to the transformer encoder 150 (embedding model). The transformer encoder projects the token sequence into an embedding vector space. The tokenizer 204, for example, may be a pre-trained model that converts text into fixed dimensional numeric vectors, sometimes referred to as input token embeddings. The tokenizer 204, for example, may be an off-the-shelf pretrained tokenizer model, which has been trained using natural language training data.

The natural language queries 202, e.g., after being converted to embeddings, are provided to both the retriever 160 and the top-K predictor 170. The retriever 160 is configured to receive the natural language queries and in response may search a database (not shown) and retrieve a set of attributes 164 predicted to have the same hash key as the natural language queries ranked by their hash distance to the natural language queries. The ranked attributes 164, for example, may each contain associated minimal schema within a graph or supergraph, when the GraphQL queries to be generated are for a graph or supergraph. Thus, the ranked attributes 164 may be associated with subschemas for the graph or supergraph. The retriever 160, for example, may be a neural database (neuralDB) based retriever that includes a transformer encoder 150 and a hash key classification head 162. The retriever 160, for example, performs a multiple class hash key prediction, in which each natural language query (i.e., the natural language query embedding) is transformed to a hash key by the transformer encoder 150 and the hash key classification head 162. The attributes that best match the natural language query are assigned the same hash key. The retriever 160, for example, may use a Merged-Average Classifiers via Hashing (MACH) or other classification algorithm, and may be trained using cross entropy loss to train the hash key classification head 162 (and optionally transformer encoder 150 and) to predict hash keys for query-result pairs such that query results that are to be retrieved together are assigned similar hash keys. The retriever 160, for example, may perform a nearest neighbor search, such as an exhaustive brute-force search as well as approximate nearest neighbor (ANN) search of a hash database based on the hash keys generated for the query. The retriever 160, for example, may independently determine a distance score between the query hash and each hash stored in the hash database, e.g., using any desired distance metric, such as, but not limited to hashed edit distance, cosine distance, squared Euclidean distance, dot product, Manhattan distance, etc. The hash with the least distance (or equivalently the highest similarity score) is considered the most relevant. The retriever 160 ranks the nearest neighbors from the hash database to produce the ranked attributes 164.

The top-K predictor 170 additionally receives the natural language queries 202, e.g., after being converted to embeddings (by the tokenizer 204 and the transformer encoder 150), and is configured to predict a number of items to be retrieved by the retriever 160 in response to each natural language query. As illustrated, the number of items to be retrieved from the top-K predictor 170 may be provided to the retriever 160, which filters the ranked attributes 164 accordingly, to produce the top-K attributes 166. In some implementations, the top-K predictor 170 may use the transformer encoder 150 from the retriever 160 to transform the natural language query embeddings to hash keys. The natural language queries, after being transformed to embeddings, serve as the input features for top-K prediction head (which can be implemented as a multi-layer perceptron 172 followed by a multi-class classifier 174). The top-K predictor 170 is configured to predict a number of items to be retrieved for each natural language query using a multi-class classification operation with the classes being different numbers of items to be retrieved. For example, the classes may be bins with different numbers of attributes to be retrieved, such as 5, 10, . . . , 100, etc. The classes, i.e., the number of items to be retrieved, may vary by regular intervals, or in some implementations, by irregular intervals. The multi-layer perceptron 172 and multi-class classifier 174 are trainable to predict the accurate top-K bins for different natural queries in the training dataset. The top-K predictor 170 may be configured, for example, to adjust the number of items to be retrieved based on various characteristics of the natural language query, including characteristics such as the complexity of the natural language query. In some implementations, the top-K predictor 170 may separately encode the natural language query, e.g., a separate transformer encoder for the top-K predictor 170 may use a different encoder model or a different feature generator.

Accordingly, as illustrated in FIG. 2, the ranked attributes 164 retrieved by the retriever 160 are limited to the top-K attributes 166 based on the number of items to be retrieved predicted by the top-K predictor 170. It should be understood that the filtering of the ranked attributes 164 to the top-K attributes 166 may occur within the retriever 160, as illustrated in FIG. 2, or may be performed externally from the retriever 160.

The top-K attributes 166 and the natural language queries 202 are provided to the prompt generator 180, which combines them as the input to the GraphQL query generating LLM 140, e.g., using a prompt template. As illustrated, LLM input, e.g., the combined top-K attributes 166 and the natural language queries 202 from prompt generator 180, may be provided to an LLM tokenizer 206 that operates on the LLM input to tokenize the input (split the input into subword token and convert the token sequence into an input embedding vector). The transformer encoder 150, for example, may be a pre-trained small (compact) encoder-only transformer architecture of standard LLMs. The LLM 140, for example, may be a 7B to 13B parameters decoder only language model. The LLM 140 receives the prompt containing the top-K attributes and the natural language queries as the LLM input, e.g., after prompt generation and tokenization, and in response generates GraphQL queries 208.

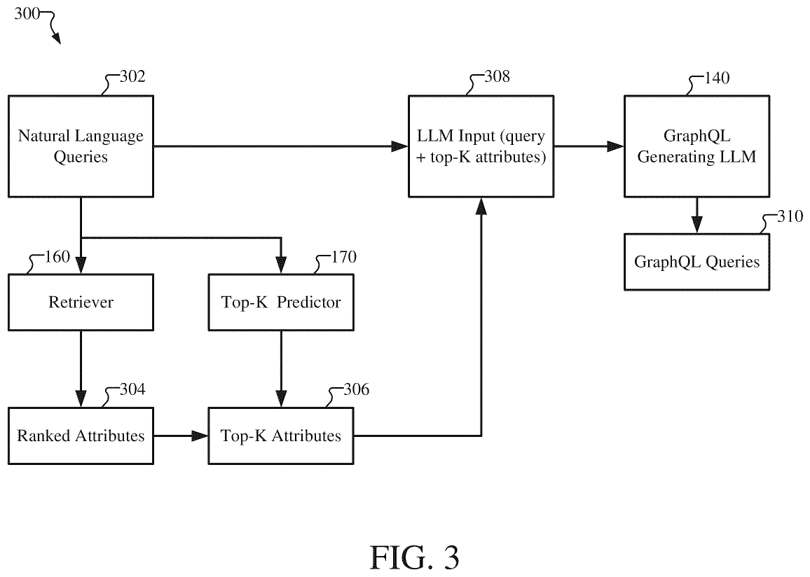

FIG. 3 illustrates a process flow 300 for GraphQL query generation using the tunable architecture 200 shown in FIG. 2. It should be understood that the process flow illustrated in FIG. 2 is generalized and additional process steps, such as encoding queries, may be performed, as discussed herein, or the order that process steps are undertaken may vary in different implementations.

As illustrated, natural language queries 302 are received, e.g., from a user via a computing device, and are provided to both the retriever 160 and the top-K predictor 170. The retriever 160 is configured to receive the natural language queries and in response may search a database (not shown) and retrieve ranked attributes 304, which may be associated with minimal schema within a graph or SuperGraph. The top-K predictor 170 additionally receives the natural language queries 302 and in response predicts a number of items to be retrieved for each natural language query. The ranked attributes 304 retrieved by the retriever 160 are limited to the top-K attributes 306 based on the number of items to be retrieved predicted by the top-K predictor 170. It should be understood that the filtering of the ranked attributes 304 to the top-K attributes 306 may occur within the retriever 160, e.g., the retriever may limit the number of ranked attributes that are retrieved to the top-K attributes 306 based on the number of items predicted by the top-K predictor 170. The top-K attributes 306 and the natural language queries 302 are combined, e.g., using a prompt template, as LLM input 308. The GraphQL query generating LLM 140 receives the LLM input and in response generates GraphQL queries 310.

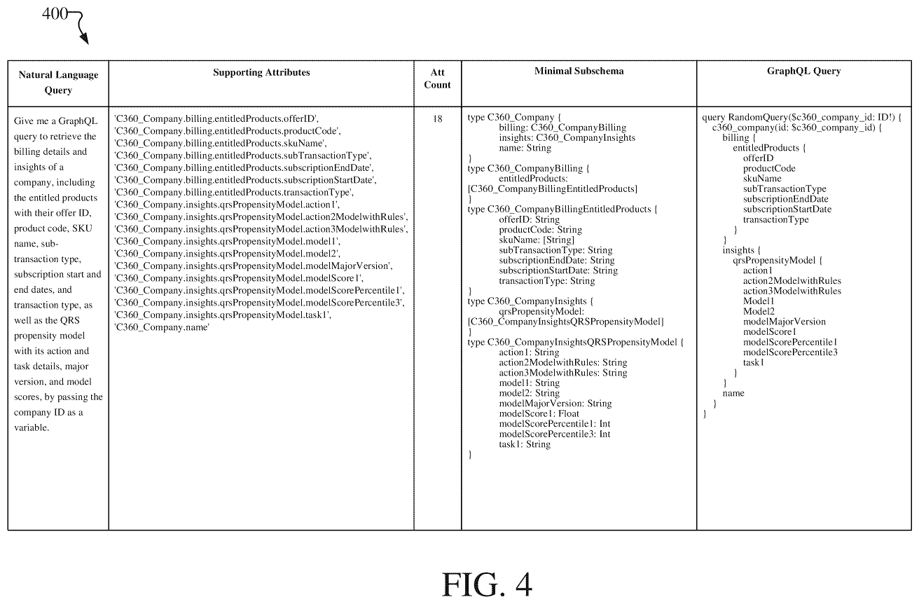

The components of the tunable architecture 200, e.g., retriever 160, top-K predictor 170, and GraphQL generating LLM 140, are fine-tuned by training. To train the components of the tunable architecture 200, a golden dataset may be constructed that includes fields, such as natural language query, supporting attributes, attribute minimal subschemas, and executable GraphQL query. FIG. 4, by way of example, illustrates an example of a training dataset 400 that may be used for training the components of architecture 200.

The architecture 200 may be trained in a multi-stage training process using a constructed training dataset. In a first stage, the retriever 160 is trained. The retriever 160, for example, is trained to retrieve a plurality of ranked attributes that are associated with natural language queries. The retriever 160 may be trained as a neuralDB retriever. For example, unlike traditional training of embedding models using contrastive objective, the neuralDB retriever training may be framed as hash key prediction (multi-class classification). The retriever 160 may be trained using cross entropy loss to train a classifier to predict hash keys for query-result pairs such that the set of query and results that should be retrieved together are assigned the same hash keys.

In a second stage of the training, the top-K predictor 170 and the GraphQL generating LLM 140 are co-trained together. An LLM input and output are constructed from the golden dataset. The LLM input, for example, consists of the natural language query and the minimal subschemas associated with the retrieved attributes from the graph or supergraph. The trained retriever 160 is used to retrieve the minimal subschemas with the maximal top-K value (largest K classes of the top-K prediction). The LLM input may be initially constructed by injecting the natural language query and the minimal schemas from the initial retrieved attributes into the prompt template. During training, both the parameters from the LLM 140 and the multi-layer perceptron layers of the top-K predictor 170 are tunable. During a training iteration, the top-K predictor predicts the top-K classes, which is used to dynamically filter out additional (extraneous) minimal subschemas from the max-top-K retrieved subschemas. Thus, the retrieval context of the LLM input is dynamically adjusted by adjusting the number of top-K attributes for different natural language queries and is dynamically adjusted during runtime. By co-training the top-K predictor 170 and the LLM 140, the LLM 140 may be trained to be able to operate with an imperfect retriever 160 by ignoring irrelevant retrieved attributes due to statistical results of the retriever 160, i.e., the LLM 140 is trained to generate the correct executable GraphQL query containing only the correct set of attributes even though there are “irrelevant” attributes in the prompt.

Additionally, during the co-training of the top-K predictor 170 and the GraphQL generating LLM 140, additional loss terms specific to GraphQL generation may be introduced, such as hallucination reduction, schema validity, and query executability losses, which move the LLM 140 towards generating hallucination free, valid, and executable queries. For example, a hallucination check validates whether the model generates fields that are not present in the supergraph. The GraphQL validation and executability checks are used both at training time (as validity loss, executability loss, and hallucination loss) and at the inference time. GraphQL query validator, for example, validates whether the generated query is a valid GraphQL query (e.g. well structured format JSON with appropriate and more). A GraphQL executability check is a production system that runs a generated query against a real SuperGraph and ensures that there are no errors. If there is a failure on the GraphQL query validator, or GraphQL executability check or both, the query validator loss and executability loss are positive and the model is penalized to adjust the weight to minimize these losses (e.g. to avoid query validator failure and executability failure in future iterations).

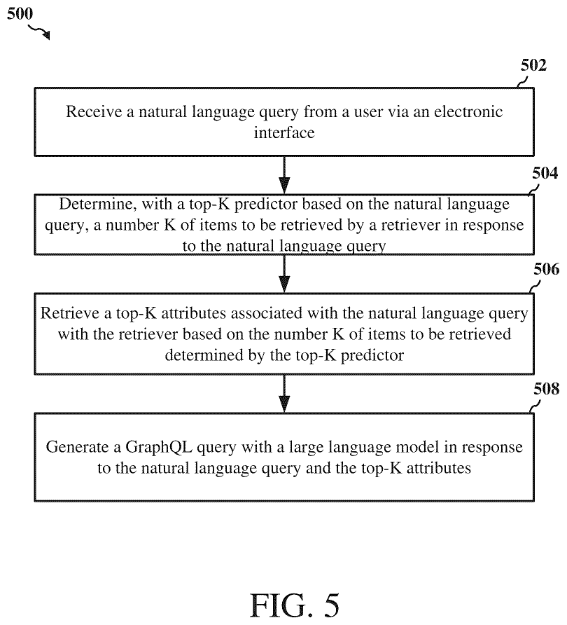

FIG. 5 shows an illustrative flowchart depicting an example method 500 for GraphQL query generation using a system with a tunable architecture including a retriever, top-K predictor, and GraphQL query generating LLM. The method 500 is described as a computer-implemented method, e.g., which may be performed by the system 100 illustrated in FIG. 1, e.g., configured with the architecture 200 shown in FIG. 2 and discussed with respect to FIG. 3.

At 502, a natural language query from a user is received via an electronic interface, e.g., as discussed in relation to the interface 120 in FIG. 1 and in relation to blocks 202 and 302 in FIGS. 2 and 3.

At 504, a number K of items to be retrieved by a retriever in response to the natural language query is determined with a top-K predictor based on the natural language query, e.g., as discussed in relation to the top-K predictor 170 in FIGS. 1, 2, and 3. In some implementations, the top-K predictor may include a multilayer perceptron with a multi-class classifier that receive the natural language queries encoded as a token sequence by the tokenizer 204 which is then embedded into a high dimensional vector space by the transformer encoder 150. In some implementations, the number K of items to be retrieved may be determined based at least partially on complexity of the natural language query. In some implementations, the number K of items to be retrieved may be determined by predicting the number of items to be retrieved based on a multi-class classification with classes that are different numbers of items to be retrieved.

At 506, a set of top-K attributes associated with the natural language query are retrieved with the retriever based on the number K of items to be retrieved determined by the top-K predictor, e.g., as discussed in relation to the retriever 160 in FIGS. 1, 2, and 3. In some implementations, the set of top-K attributes associated with the natural language query are retrieved by performing a multiple class hash key prediction by encoding the natural language query with a hash key and retrieving attributes that are assigned the same hash key. The retriever, in some implementations, is a neural database retriever.

At 508, a GraphQL query is generated with a large language model in response to the natural language query and the set of top-K attributes, e.g., as discussed in relation to the LLM 140 in FIGS. 1, 2, and 3. The set of top-K attributes, for example, may contain associated minimal schema within a SuperGraph, wherein the GraphQL query is for the SuperGraph.

In some implementations, the top-K predictor and the large language model may be co-trained, with the top-K predictor trained to dynamically reduce a number of attributes in the top-K attributes based on different natural language queries and the large language model trained to ignore irrelevant retrieved attributes due to statistical results of the retriever. The top-K predictor and the large language model may be further co-trained on loss terms including at least one of hallucination reduction loss, schema validity loss, and query executability loss.

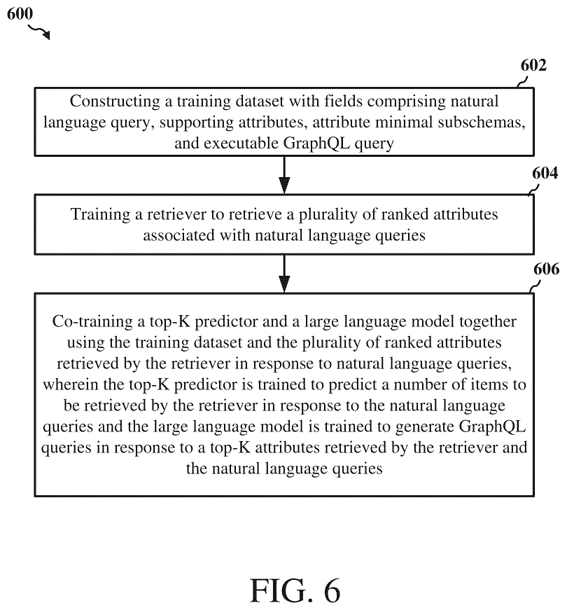

FIG. 6 shows an illustrative flowchart depicting an example method 600 for training a system for GraphQL query generation with a system with a tunable architecture including a retriever, top-K predictor, and GraphQL query generating LLM. The method 600 is described as a computer-implemented method, e.g., which may be performed by the system 100 illustrated in FIG. 1, e.g., configured with the architecture 200 shown in FIG. 2 and discussed with respect to FIG. 3.

At 602, a training dataset is constructed with fields comprising natural language query, supporting attributes, attribute minimal subschemas, and executable GraphQL query, e.g., as discussed in relation to FIG. 4.

At 604, a retriever is trained to retrieve a plurality of ranked attributes associated with natural language queries, e.g., as discussed in relation to the retriever 160 in FIGS. 1, 2, and 3. In some implementations, training the retriever may include training to perform a multiple class hash key prediction such that each natural language query and the corresponding retrieved attributes are assigned a same hash key. For example, training the retriever may include using cross entropy loss to train a classifier to predict hash keys for query-result pairs such that query results that are to be retrieved together are assigned the same hash keys. The retriever, for example, may be a neural database retriever.

At 606, a top-K predictor and a large language model are co-trained together using the training dataset and the plurality of ranked attributes retrieved by the retriever in response to natural language queries, wherein the top-K predictor is trained to predict a number of items to be retrieved by the retriever in response to the natural language queries and the large language model is trained to generate GraphQL queries in response to a set of top-K attributes retrieved by the retriever and the natural language queries, e.g., as discussed in relation to the top-K predictor 170 and LLM 140 in FIGS. 1, 2, and 3. In some implementations, the co-training of the top-K predictor and the large language model together may include training on loss terms comprising at least one of hallucination reduction loss, schema validity loss, and query executability loss.

In some implementations, the top-K predictor and the large language model are co-trained together includes using the retriever to retrieve the attribute minimal subschemas with a maximal top-K value in response to a natural language query from the training dataset and constructing an input to the large language model comprising the natural language query and the attribute minimal subschemas with the maximal top-K value from the retriever. The top-K predictor is trained to reduce the top-K value for the natural language query to dynamically filter out attribute minimal subschemas from the plurality of ranked attributes retrieved by the retriever and the large language model is trained to ignore irrelevant retrieved attributes due to statistical results of the retriever.

In some implementations, the retriever and the top-K predictor may encode the natural language query with a shared encoder, i.e., the retriever and the top-K predictor use with a same encoder.

In some implementations, the top-K predictor may include a multilayer perceptron with a multi-class classifier that receives the natural language queries encoded as hash keys. The top-K predictor may be trained to alter a number of items to be retrieved based at least partially on complexity of the natural language query. The top-K predictor may be trained to predict the number of items to be retrieved based on a multi-class classification with classes that are different numbers of items to be retrieved.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “generating,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described, in terms of functionality, and illustrated in the various illustrative components, blocks, modules, circuits and processes described above. Whether such functionality is implemented in hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the broadest scope consistent with this disclosure, the principles and the novel features disclosed herein.

1. A system configured for GraphQL query generation, comprising:
one or more processors; and
a memory communicatively coupled with the one or more processors and storing instructions that, when executed by the one or more processors, cause the one or more processors to be configured as:
a top-K predictor that is configured to receive a natural language query and in response predict a number of items to be retrieved for the natural language query;
a retriever that is configured to receive the natural language query and in response retrieve a set of top-K attributes based on a plurality of ranked attributes associated with the natural language query and the number of items to be retrieved; and
a large language model that is configured to receive the set of top-K attributes and the natural language query and in response generate a GraphQL query.

2. The system of claim 1, wherein the retriever and the top-K predictor encode the natural language query with a same text encoder.

3. The system of claim 1, wherein the retriever is trained to perform a multiple class hash key prediction by encoding each natural language query with a hash key and to retrieve attributes that are assigned a same hash key.

4. The system of claim 3, wherein the retriever is trained using cross entropy loss to train a classifier to predict hash keys for query-result pairs such that query results that are to be retrieved together are assigned the same hash keys.

5. The system of claim 1, wherein each attribute in the set of top-K attributes contains associated minimal schema within a SuperGraph, wherein the GraphQL query are for the SuperGraph.

6. The system of claim 1, wherein the top-K predictor comprises a multilayer perceptron with a multi-class classifier that receives the natural language query encoded as hash keys.

7. The system of claim 1, wherein the top-K predictor is configured to alter a number of items to be retrieved based at least partially on complexity of the natural language query.

8. The system of claim 1, wherein the top-K predictor is configured to predict the number of items to be retrieved based on a multi-class classification with classes that are different numbers of items to be retrieved.

9. The system of claim 1, wherein the top-K predictor and the large language model are co-trained, with the top-K predictor trained to dynamically reduce a number of attributes in the set of top-K attributes based on different natural language queries and the large language model trained to ignore irrelevant retrieved attributes due to statistical results of the retriever.

10. The system of claim 9, wherein the top-K predictor and the large language model are further co-trained on loss terms comprising at least one of hallucination reduction loss, schema validity loss, and query executability loss.

11. A method for GraphQL query generation, comprising:
receiving a natural language query from a user via an electronic interface;
determining, with a top-K predictor based on the natural language query, a number K of items to be retrieved by a retriever in response to the natural language query;
retrieving a set of top-K attributes associated with the natural language query with the retriever based on the number K of items to be retrieved determined by the top-K predictor; and
generating a GraphQL query with a large language model in response to the natural language query and the set of top-K attributes.

12. The method of claim 11, further comprising encoding the natural language query with a same encoder shared by the retriever and the top-K predictor.

13. The method of claim 11, wherein retrieving the set of top-K attributes associated with the natural language query comprises performing a multiple class hash key prediction by encoding the natural language query with a hash key and retrieving attributes that are assigned a same hash key.

14. The method of claim 11, wherein the set of top-K attributes contain associated minimal schema within a SuperGraph, wherein the GraphQL query is for the SuperGraph.

15. The method of claim 11, wherein the top-K predictor comprises a multilayer perceptron with a multi-class classifier that receive the natural language query encoded as hash keys.

16. The method of claim 11, wherein determining the number K of items to be retrieved is based at least partially on complexity of the natural language query.

17. The method of claim 11, wherein determining the number K of items to be retrieved comprises predicting the number K of items to be retrieved based on a multi-class classification with classes that are different numbers of items to be retrieved.

18. The method of claim 11, wherein the top-K predictor and the large language model are co-trained, with the top-K predictor trained to dynamically reduce a number of attributes in the set of top-K attributes based on different natural language queries and the large language model trained to ignore irrelevant retrieved attributes due to statistical results of the retriever.

19. The method of claim 18, wherein the top-K predictor and the large language model are further co-trained on loss terms comprising at least one of hallucination reduction loss, schema validity loss, and query executability loss.

20. A method for training a system for GraphQL query generation, comprising:
constructing a training dataset with fields comprising natural language query, supporting attributes, attribute minimal subschemas, and executable GraphQL query;
training a retriever to retrieve a plurality of ranked attributes associated with natural language queries; and
co-training a top-K predictor and a large language model together using the training dataset and the plurality of ranked attributes retrieved by the retriever in response to natural language queries, wherein the top-K predictor is trained to predict a number of items to be retrieved by the retriever in response to the natural language queries and the large language model is trained to generate GraphQL queries in response to a set of top-K attributes retrieved by the retriever and the natural language queries.

21. The method of claim 20, wherein co-training the top-K predictor and the large language model together comprises:
using the retriever to retrieve the attribute minimal subschemas with a maximal top-K value in response to a natural language query from the training dataset;
constructing an input to the large language model comprising the natural language query and the attribute minimal subschemas with the maximal top-K value from the retriever;
training the top-K predictor to reduce a top-K value for the natural language query to dynamically filter out attribute minimal subschemas from the plurality of ranked attributes retrieved by the retriever; and
training the large language model to ignore irrelevant retrieved attributes due to statistical results of the retriever.

22. The method of claim 20, wherein co-training the top-K predictor and the large language model together comprises training on loss terms comprising at least one of hallucination reduction loss, schema validity loss, and query executability loss.

23. The method of claim 20, wherein training the retriever comprises training to perform a multiple class hash key prediction by encoding each natural language query with a hash key and to retrieve attributes that are assigned a same hash key.

24. A system configured for GraphQL query generation, comprising:
one or more processors; and
a memory communicatively coupled with the one or more processors and storing instructions that, when executed by the one or more processors, causes the one or more processors to perform operations including:
constructing a training dataset with fields comprising natural language query, supporting attributes, attribute minimal subschemas, and executable GraphQL query;
training a retriever to retrieve a plurality of ranked attributes associated with natural language queries; and
co-training a top-K predictor and a large language model together using the training dataset and the plurality of ranked attributes retrieved by the retriever in response to natural language queries, wherein the top-K predictor is trained to predict a number of items to be retrieved by the retriever in response to the natural language queries and the large language model is trained to generate GraphQL queries in response to a set of top-K attributes retrieved by the retriever and the natural language queries.

25. The system of claim 24, wherein the one or more processors are caused to perform co-training the top-K predictor and the large language model together by:
using the retriever to retrieve the attribute minimal subschemas with a maximal top-K value in response to a natural language query from the training dataset;
constructing an input to the large language model comprising the natural language query and the attribute minimal subschemas with the maximal top-K value from the retriever;
training the top-K predictor to reduce a top-K value for the natural language query to dynamically filter out attribute minimal subschemas from the plurality of ranked attributes retrieved by the retriever; and
training the large language model to ignore irrelevant retrieved attributes due to statistical results of the retriever.

26. The system of claim 24, wherein the one or more processors are caused to perform co-training the top-K predictor and the large language model together by training on loss terms comprising at least one of hallucination reduction loss, schema validity loss, and query executability loss.

27. The system of claim 24, wherein the one or more processors are caused to perform training the retriever by training to perform a multiple class hash key prediction by encoding each natural language query with a hash key and to retrieve attributes that are assigned a same hash key.
